(19) United States
(12) Patent Application Publication
(10) Pub. No.: US 2015/0056039 A1
(43) Pub. Date: Feb. 26, 2015

(54) INTERNALLY THREADED POST, ASSEMBLING STRUCTURE AND ASSEMBLING METHOD

(71) Applicant: Wistron Corporation, New Taipei City (TW)

(72) Inventors: Zhang-Rong Jin, New Taipei City (TW); Te-Hsiung Hsieh, New Taipei City (TW)

(73) Assignee: Wistron Corporation, New Taipei City (TW)

(21) Appl. No.: 14/071,647

(22) Filed: Nov. 5, 2013

(30) Foreign Application Priority Data
Aug. 20, 2013 (CN) 201310364832.7

(51) Int. Cl. F16B 13/06; B23P 19/04

(52) U.S. Cl. CPC F16B 13/06; B23P 19/04
USPC 411/80.6; 29/525.11; 29/525.14

(57) ABSTRACT

An internally threaded post adapted to be fixed to a first shell is provided. The first shell has a boss, and the boss has an opening. The internally threaded post includes a screwing portion and a fixing portion. The screwing portion has a threaded hole, in which an outer diameter of the screwing portion is larger than an inner diameter of the opening. The fixing portion is connected with the screwing portion, in which an outer diameter of the fixing portion is smaller than the outer diameter of the screwing portion, and the fixing portion is fixed in the opening. In addition, an assembling structure having the internally threaded post and an assembling method are also provided.

### CROSS-REFERENCE TO RELATED APPLICATION

This application claims the priority benefit of China application serial no. 201310364832.7, filed on Aug. 20, 2013. The entirety of the above-mentioned patent application is hereby incorporated by reference herein and made a part of this specification.

### BACKGROUND OF THE INVENTION

1. Field of the Invention

The invention relates to an internally threaded post, an assembling structure and an assembling method, and more particularly, to an internally threaded post, an assembling structure and an assembling method, capable of saving disposition space.

2. Description of Related Art

With advancements in technology industry, various electronic devices including products such as smart phones, notebook computers and tablet PCs have been widely adopted and developed to meet design requirements of easy operation, multiple functionality, and attractive exterior design for users to choose from.

A shell in an electronic device may include an internally threaded post, and the internally threaded post has a threaded hole to which screws are screwed on for assembling the electronic device. More specifically, the shell is, for example, a plastic part having a boss being integrally formed thereon, and the internally threaded post is embedded in an opening of the boss to be fixed in the shell. Generally, a size of the boss is designed according to specifications of the internally threaded post and the screws, so as to prevent the boss from damages during the screwing process due to poor structural strength. However, the boss with larger size occupying more disposition space inside the electronic device, resulting in restrictions to ways for disposing other members, which is also against a slim design trend for the electronic devices.

### SUMMARY OF THE INVENTION

The invention is directed to an internally threaded post, an assembling structure and an assembling method, capable of saving disposing space.

An internally threaded post of the invention is adapted to be fixed to a first shell. The first shell has a boss, and the boss has an opening. The internally threaded post includes a screwing portion and a fixing portion. The screwing portion has a threaded hole, in which an outer diameter of the screwing portion is larger than an inner diameter of the opening. The fixing portion is connected with the screwing portion, in which an outer diameter of the fixing portion is smaller than the outer diameter of the screwing portion, and the fixing portion is fixed in the opening.

An assembling structure of the invention includes a first shell and an internally threaded post. The first shell has a boss, and the boss has an opening. The internally threaded post includes a screwing portion and a fixing portion. The screwing portion has a threaded hole, in which an outer diameter of the screwing portion is larger than an inner diameter of the opening. The fixing portion is connected with the screwing portion, in which an outer diameter of the fixing portion is smaller than the outer diameter of the screwing portion, and the fixing portion is fixed in the opening.

In an embodiment of the invention, the screwing portion is leant against a top end of the boss.

In an embodiment of the invention, a second shell has a through hole, and a screwing element is adapted to pass through the through hole and screwed in the threaded hole for assembling the second shell to the first shell.

In an embodiment of the invention, the fixing portion has a first flange at least partially embedded in an inner wall of the opening.

In an embodiment of the invention, a surface of the first flange has a plurality of first concave patterns.

In an embodiment of the invention, the fixing portion further has a second flange at least partially embedded in the inner wall of the opening, and a surface of the second flange has a plurality of second concave patterns. An extending direction of the first concave patterns is different from an extending direction of the second concave patterns.

In an embodiment of the invention, a length of the fixing portion is equal to a depth of the opening.

An assembling method of the invention includes the following steps. A first shell is provided, in which the first shell has a boss, and the boss has an opening. An internally threaded post is provided, in which the internally threaded post includes a screwing portion and a fixing portion, and the screwing portion has a threaded hole, in which an outer diameter of the screwing portion is larger than an inner diameter of the opening, and an outer diameter of the fixing portion is smaller than the outer diameter of the screwing portion. The fixing portion is fixed in the opening.

In an embodiment of the invention, the assembling method further includes the following steps. A second shell is provided, in which the second shell has a through hole. A screwing element is provided to pass through the through hole and to be screwed in the threaded hole for fixing the second shell to the first shell.

In an embodiment of the invention, a step of fixing the fixing portion in the opening includes a thermo process.

In an embodiment of the invention, a step of fixing the fixing portion in the opening includes an insert injection molding process.

Based on above, the internally threaded post of the invention includes the screwing portion with larger outer diameter and the fixing portion with smaller outer diameter, in which the threaded hole is located at the screwing portion, and the fixing portion is configured to be fixed to the boss of the first shell. Based on design method aforementioned, the internally threaded post may be assembled to the first shell by only having the fixing portion embedded in the opening of the boss without having the screwing portion embedded in the opening of the boss. Therefore, specifications of the screwing portion and the threaded hole thereof are not restricted. From another prospective, since it is not required for the opening of the boss to accommodate the screwing portion having larger outer diameter, the boss can be small in size to achieve an effect of saving disposition space.

To make the above features and advantages of the disclosure more comprehensible, several embodiments accompanied with drawings are described in detail as follows.

### BRIEF DESCRIPTION OF THE DRAWINGS

FIG. 1 is a side view of an internally threaded post according to an embodiment of the invention.

FIG. 2 is a cross-sectional view of the internally threaded post of FIG. 1.

FIG. 3 is a cross-sectional view of the internally threaded post of FIG. 2 assembled to the first shell.

FIG. 4 is a cross-sectional view for assembling the assembling structure of FIG. 3 with the second shell.

FIG. 5 is a cross-sectional view of an assembling structure according to another embodiment of the invention.

FIG. 6 is a cross-sectional view for assembling the assembling structure with the second shell according to another embodiment of the invention.

FIG. 7 is a flowchart of an assembling method according to an embodiment of the invention.

### DESCRIPTION OF THE EMBODIMENTS

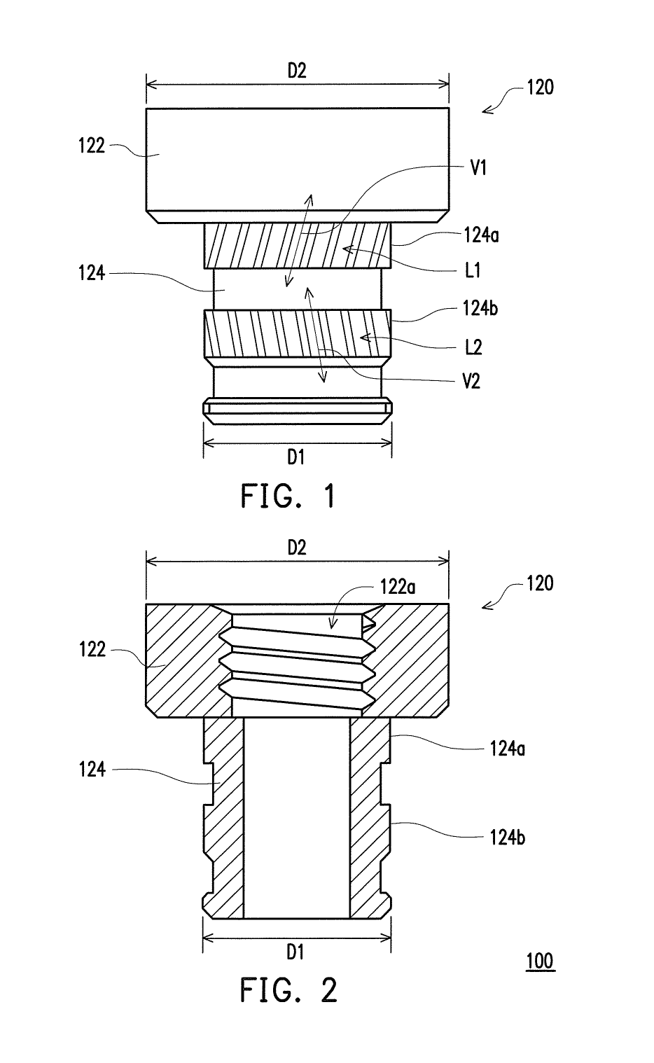

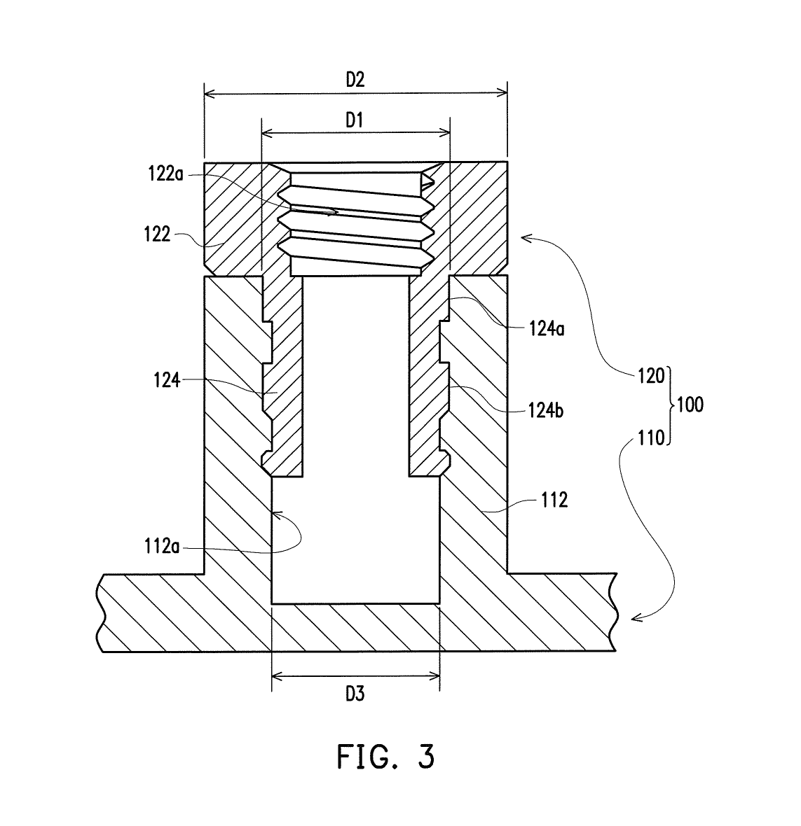

FIG. 1 is a side view of an internally threaded post according to an embodiment of the invention. FIG. 2 is a cross-sectional view of the internally threaded post of FIG. 1. FIG. 3 is a cross-sectional view of the internally threaded post of FIG. 2 assembled to the first shell. Referring to FIG. 1 and FIG. 2, an internally threaded post 120 of the present embodiment includes a screwing portion 122 and a fixing portion 124. The screwing portion 122 has a threaded hole 122a. The fixing portion 124 connects with the screwing portion 122, and an outer diameter D1 of the fixing portion 124 is smaller than an outer diameter D2 of the screwing portion 122. Referring to FIG. 3, the internally threaded post 120 is adapted to be fixed to a first shell 110 to compose an assembling structure 100. More specifically, the first shell 110 has a boss 112, and the boss 112 has an opening 112a. The outer diameter D2 of the screwing portion 122 is larger than an inner diameter D3 of the opening 112a of the boss 112. The fixing portion 124 is fixed in the opening 112a of the boss 112, and the screwing portion 122 is leant against a top end of the boss 112.

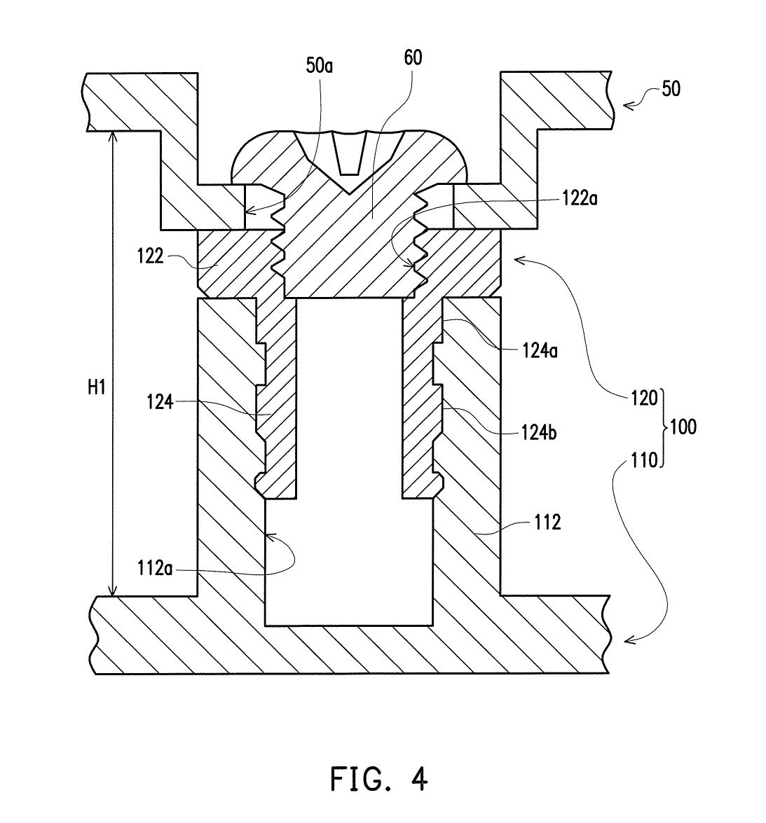

FIG. 4 is a cross-sectional view for assembling the assembling structure of FIG. 3 with the second shell. Referring to FIG. 4, a second shell 50 has a through hole 50a, a screwing element 60 (e.g., a screw) which is adapted to pass through the through hole 50a of the second shell 50 and to be screwed in the threaded hole 122a of the internally threaded post 120 for assembling the second shell 50 to the first shell 110.

In the present embodiment, the first shell 110 and the second shell 50 are both a shell of a portable electronic device for example. Based on design method aforementioned, the internally threaded post 120 may be assembled to the first shell 110 by only having the fixing portion 124 of the internally threaded post 120 embedded in the opening 112a of the boss 112 without having the screwing portion 122 of the internally threaded post 120 embedded in the opening 112a of the boss 112. Therefore, specifications of the screwing portion 122 and the threaded hole 122a thereof are not restricted. From another prospective, since it is not required for the opening 112a of the boss 112 to accommodate the screwing portion 122 having larger outer diameter, the boss 112 can be small in size to achieve an effect of saving disposition space of the portable electronic device, so as meet a slim design trend for the portable electronic device.

In the present embodiment, a material of the first shell 100 and the boss 112 thereof is, for example, plastic, and the boss 112 is fixed together with the fixing portion 124 of the internally threaded post 120 by a thermo process or an insert injection molding process. Referring to FIG. 1, the fixing portion 124 of the internally threaded post 120 has a first flange 124a and a second flange 124b. After the thermo process or the insert injection molding process is performed, the first flange 124a is at least partially embedded in an inner wall of the opening 112a of the boss 112, as shown in FIG. 3. Furthermore, the second flange 124b is also at least partially embedded in the inner wall of the opening 112a of the boss 112, as shown in FIG. 3. Accordingly, the fixing portion 124 of the internally threaded post 120 can be steadily fixed in the opening 112a of the boss 112.

Referring to FIG. 1, more specifically, a surface of the first flange 124a of the fixing portion 124 has a plurality of first concave patterns L1, and a surface of the second flange 124b of the fixing portion 124 has a plurality of second concave patterns L2. After the thermo process or the insert injection molding process is performed, a part of the material at the inner wall of the opening 112a of the boss 112 enters the first concave patterns L1 and the second concave patterns L2, so that the first flange 124a and the second flange 124b can be tightly combined to the inner wall of the opening 112a through the first concave patterns L1 and the second concave patterns L2, respectively. In the present embodiment, an extending direction V1 of the first concave patterns L1 is, for example, different from an extending direction V2 of the second patterns L2, so that the fixing portion 124 and the boss 122 can have a favorable combining strength in all directions to prevent damages to a combination between the internally threaded post 120 and the boss 112 due to force applied during a process of screwing the screwing element 60 (as illustrated in FIG. 4) to the internally threaded post 120.

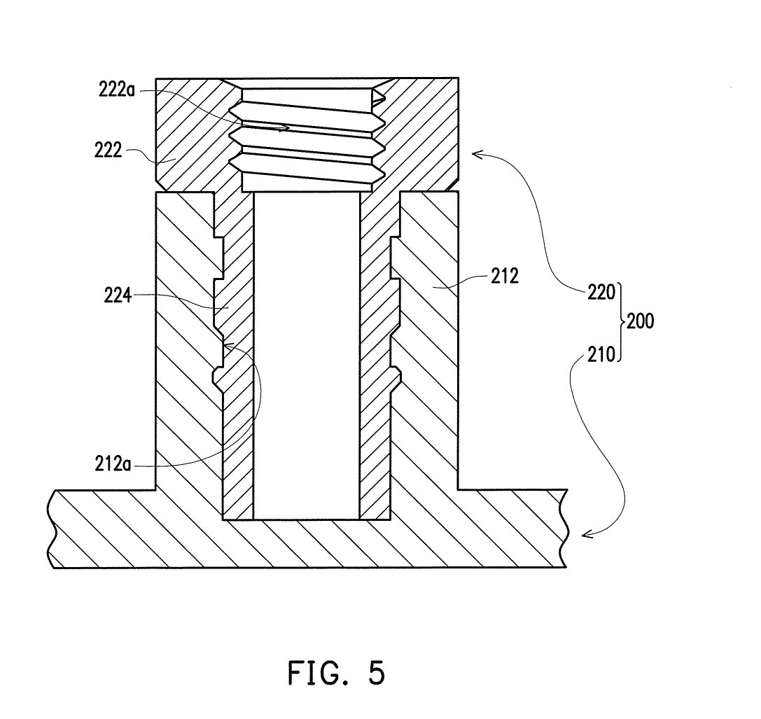

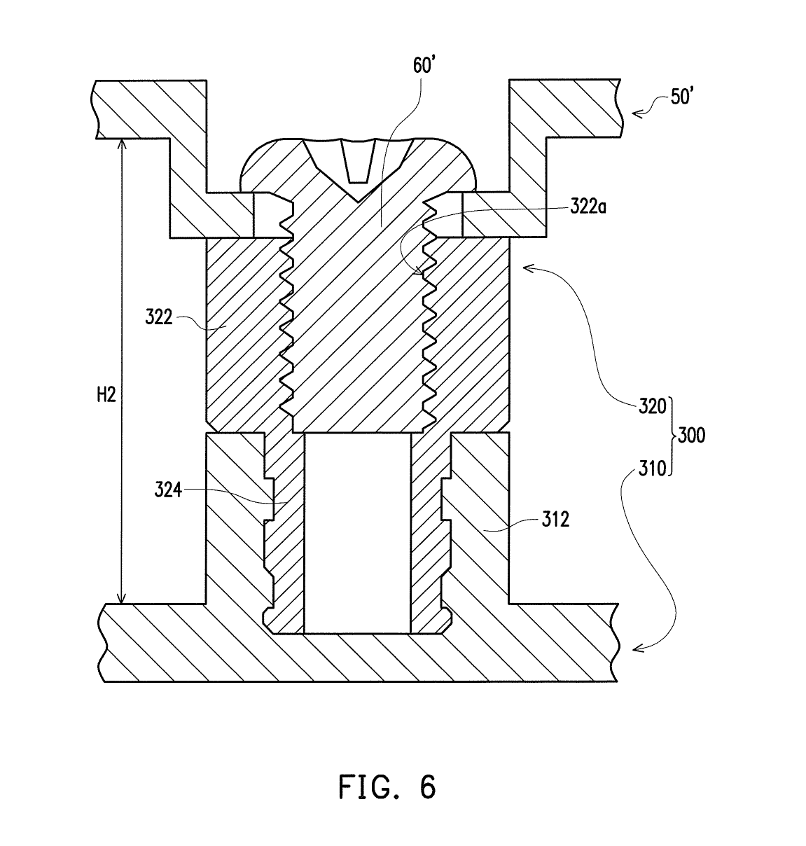

FIG. 5 is a cross-sectional view of an assembling structure according to another embodiment of the invention. Referring to FIG. 5, in an assembling structure 200 of the present embodiment, a disposition method of a screwing portion 222 of an internally threaded post 220 is similar to the disposition method of the screwing portion 122 depicted in FIG. 3, thus related description is omitted hereinafter. A difference between the assembling structure 200 and the assembling structure 100 is that, a length of a fixing portion 224 of the internally threaded post 220 is equal to a depth of an opening 212a of a boss 212 of a first shell 210. In other words, the fixing portion 224 of the internally threaded post 220 is extended to a bottom end of the opening 212a to include a greater length. Accordingly, when the first shell 210 and the boss 212 are formed by the insert injection molding process, a shrink at bottom of the boss 212 can be prevented, and a possibility for the plastic material to leak from a bottom end of the fixing portion 224 into a threaded hole 222a of the screwing portion 222 can also be reduced.

FIG. 6 is a cross-sectional view for assembling the assembling structure with the second shell according to another embodiment of the invention. A distance H2 between a first shell 310 and a second shell 50′ depicted in FIG. 6 is equal to a distance H1 between the first shell 110 and the second shell 50 depicted in FIG. 4. A difference between an assembling structure 300 of FIG. 6 and the assembling structure 100 of FIG. 4 is that, a height of a boss 312 of the first shell 310 is smaller than a height of the boss 112 of the first shell 110, and a height of a screwing portion 322 of an internally threaded post 320 is larger than a height of the screwing portion 122 of the internally threaded post 120. By adjusting the heights of the boss 312 and the screwing portion 322 to be different from that of the embodiment depicted in FIG. 4, an extending length of a threaded hole 322a can be increased without changing the distance between the first shell and the second shell, so as to meet a design requirement for enhancing a screwing strength of a screw 60′.

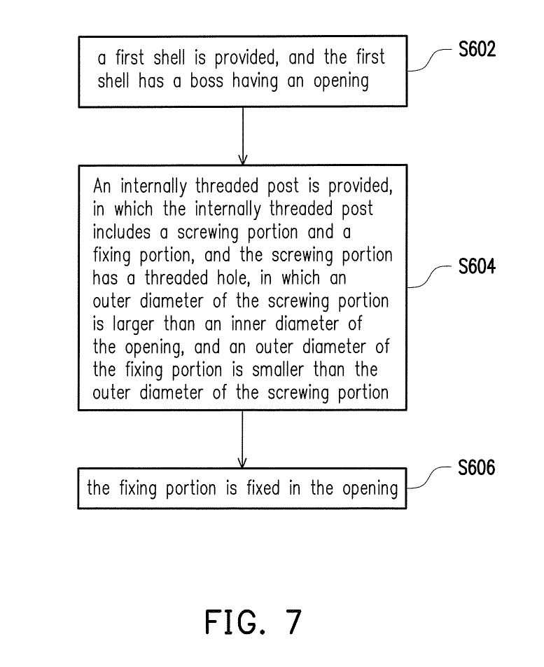

An assembling method of the invention is described below with reference to the structures depicted in FIG. 1 through FIG. 4. FIG. 7 is a flowchart of an assembling method according to an embodiment of the invention. Referring to FIG. 7, a first shell 110 (as illustrated in FIG. 3 and FIG. 4) is provided, and a first shell 110 has a boss 112 having an opening 112a (step S602). An internally threaded post 120 (as illustrated in FIG. 1 through FIG. 4) is provided, in which the internally threaded post 120 includes a screwing portion 122 and a fixing portion 124, and the screwing portion 122 has a threaded hole 122a, in which an outer diameter D2 of the screwing portion 122 is larger than an inner diameter D3 of the opening 112a, and an outer diameter D1 of the fixing portion 124 is smaller than the outer diameter D2 of the screwing portion 122 (step S604). As shown in FIG. 3, the fixing portion 124 is fixed in the opening 112a (step S606). In step S606, the fixing portion 124 is fixed in the opening 112a by using a thermo process or an insert injection molding process. After step S606 is performed, the following steps can be further performed. A second shell 50 (as illustrated in FIG. 4) is provided, and the second shell 50 includes a through hole 50a. Subsequently, a screwing element 60 is provided to pass through the through hole 50a and to be screwed in the threaded hole 122a for fixing the second shell 50 to the first shell 110.

In summary, the internally threaded post of the invention includes the screwing portion with larger outer diameter and the fixing portion with smaller outer diameter, in which the threaded hole is located at the screwing portion, and the fixing portion is configured to be fixed to the boss of the first shell. Based on design method aforementioned, the internally threaded post may be assembled to the first shell by only having the fixing portion embedded in the opening of the boss without having the screwing portion embedded in the opening of the boss. Therefore, specifications of the screwing portion and the threaded hole thereof are not restricted. From another prospective, since it is not required for the opening of the boss to accommodate the screwing portion having larger outer diameter, the boss can be small in size to achieve an effect of saving disposition space. In addition, the length of the fixing portion of the internally threaded post can be designed to be equal to the depth of the opening of the boss of the first shell, so that the fixing portion is extended to a bottom end of the opening to include a greater length. Accordingly, when the first shell and the boss are formed by the insert injection molding process, a shrink at bottom of the boss can be prevented, and a possibility for the plastic material to leak from a bottom end of the fixing portion into a threaded hole of the screwing portion can also be reduced.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An internally threaded post adapted to be fixed to a first shell, the first shell having a boss, the boss having an opening, and the internally threaded post comprising:
a screwing portion having a threaded hole, wherein an outer diameter of the screwing portion is larger than an inner diameter of the opening; and
a fixing portion connecting with the screwing portion, wherein an outer diameter of the fixing portion is smaller than the outer diameter of the screwing portion, and the fixing portion is fixed in the opening.

2. The internally threaded post of claim 1, wherein the screwing portion is leant against a top end of the boss.

3. The internally threaded post of claim 1, wherein a second shell has a through hole, and a screwing element is adapted to pass through the through hole and screwed in the threaded hole for assembling the second shell to the first shell.

4. The internally threaded post of claim 1, wherein the fixing portion has a first flange at least partially embedded in an inner wall of the opening.

5. The internally threaded post of claim 4, wherein a surface of the first flange has a plurality of first concave patterns.

6. The internally threaded post of claim 5, wherein the fixing portion further has a second flange at least partially embedded in the inner wall of the opening, and a surface of the second flange has a plurality of second concave patterns, wherein an extending direction of the first concave patterns is different from an extending direction of the second concave patterns.

7. The internally threaded post of claim 1, wherein a length of the fixing portion is equal to a depth of the opening.

8. An assembling structure, comprising:
a first shell having a boss, wherein the boss has an opening; and
an internally threaded post, comprising:
a screwing portion having a threaded hole, wherein an outer diameter of the screwing portion is larger than an inner diameter of the opening; and
a fixing portion connecting with the screwing portion, wherein an outer diameter of the fixing portion is smaller than the outer diameter of the screwing portion, and the fixing portion is fixed in the opening.

9. The assembling structure of claim 8, wherein the screwing portion is leant against a top end of the boss.

10. The assembling structure of claim 8, wherein a second shell has a through hole, and a screwing element is adapted to pass through the through hole and screwed in the threaded hole for assembling the second shell to the first shell.

11. The assembling structure of claim 8, wherein the fixing portion has a first flange at least partially embedded in an inner wall of the opening.

12. The assembling structure of claim 11, wherein a surface of the first flange has a plurality of first concave patterns.

13. The assembling structure of claim 12, wherein the fixing portion further has a second flange at least partially embedded in the inner wall of the opening, and a surface of the second flange has a plurality of second concave patterns, wherein an extending direction of the first concave patterns is different from an extending direction of the second concave patterns.

14. The assembling structure of claim 8, wherein a length of the fixing portion is equal to a depth of the opening.

15. An assembling method, comprising:
providing a first shell, wherein the first shell has a boss, and the boss has an opening;
providing an internally threaded post, wherein the internally threaded post comprises a screwing portion and a fixing portion, and the screwing portion has a threaded hole, wherein an outer diameter of the screwing portion is larger than an inner diameter of the opening, and an outer diameter of the fixing portion is smaller than the outer diameter of the screwing portion; and
fixing the fixing portion in the opening.

16. The assembling method of claim 15, further comprising:
providing a second shell, wherein the second shell has a through hole; and
providing a screwing element to pass through the through hole and to be screwed in the threaded hole for fixing the second shell to the first shell.

17. The assembling method of claim 15, wherein a step of fixing the fixing portion in the opening comprises a thermo process.

18. The assembling method of claim 15, wherein a step of fixing the fixing portion in the opening comprises an insert injection molding process.
